(19) United States
(12) Patent Application Publication
(10) Pub. No.: US 2010/0047042 A1
(43) Pub. Date: Feb. 25, 2010

(54) Mobile Drill Cuttings Drying System

(75) Inventor: Joseph Cyprian Templet, III, Lafayette, LA (US)

Correspondence Address: LAW OFFICE OF JESSE D. LAMBERT, L.L.C., 406 AUDUBON BLVD., LAFAYETTE, LA, 70503, US

(73) Assignee: ENVIRONMENTAL DRILLING SOLUTIONS, LLC, Maurice, LA (US)

(21) Appl. No.: 12/606,296

(22) Filed: Oct. 27, 2009

Related U.S. Application Data
(60) Provisional application No. 61/170,696, filed on Apr. 20, 2009.

(51) Int. Cl. B65G 25/00

(52) U.S. Cl. 414/158; 414/804

(57) ABSTRACT

Apparatus for drying drill cuttings (“cuttings”) at multiple drilling locations. A commercially available cuttings drying unit is mounted on a means for transporting the cuttings drying unit between drilling sites, such as a truck. A means for conveying cuttings to an inlet of the cuttings drying unit, such as an auger, moves wet cuttings from a collection container to the drying unit. The cuttings are then dried. A means for conveying dried cuttings from a discharge of the cuttings drying unit to another cuttings container, such as a discharge auger, is provided. Preferably the discharge auger is mounted on the truck so as to be rotatable between a first position, wherein the truck can legally move down a roadway (preferably, contained within the width of the truck), and a second position usually to one side of the truck, where the dried cuttings can be discharged into a container. The cuttings drying system can be readily transported between drilling locations, remaining only long enough to process the wet cuttings on location. In one embodiment of the invention, the inlet auger is mounted on the truck, so that it is moved from location to location as well.

### CROSS REFERENCE TO RELATED APPLICATIONS

This regular patent application claims priority to U.S. Provisional Patent Application Ser. No. 61/170696, filed Apr. 20, 2009, for all purposes.

### BACKGROUND

1. Field of the Invention

This invention relates generally to apparatus and method used in conjunction with the drilling and servicing of oil and gas wells, and wells drilled for other purposes such as saltwater disposal wells, in an onshore environment. With further specificity, this invention relates to an apparatus for drying drill cuttings (that is, the earthen cuttings generated in the process of boring a borehole into the earth, referred to hereafter as “drill cuttings” or “cuttings”), where the apparatus (the cuttings drying unit) is mounted on a movable platform such as a truck or truck/trailer and moved to a drilling location, once a volume of cuttings have accumulated. For purposes of this application, the term “drying” means removal of at least a portion of the liquids which are contained within or on the surface of the cuttings. Once the accumulated cuttings have been dried, the unit can be moved to another location and the process repeated. The system of the present invention is therefore at the drilling location for a time substantially less than the entire duration of the time to drill the well, thereby greatly reducing costs for cuttings drying, as compared to units which remain at the drilling location for the entire duration of the drilling process.

2. Related Art

As is well known in the relevant art, drill cuttings are brought to the surface in the drilling mud stream. The mud stream flows through various solids control equipment, which has the ultimate goal of separating the drill cuttings from the mud, and returning the mud to the circulating system. The drill cuttings, which when separated from the mud are coated with mud and quite wet, must then be handled.

Certain operational situations present issues with cuttings handling and disposal. For example, some drill sites are so-called “zero discharge” sites, at which drill cuttings cannot be simply dumped into a pit, regardless of the base type of drilling mud, whether oil-based or water based. In virtually all settings today, where an oil based mud system is used, the cuttings must be placed into containers for proper disposal. In addition, there is an economic incentive to remove as much of the expensive liquid phase of the oil base mud as possible, in order to return it to the system.

In short, a significant economic incentive exists to capture drill cuttings, and remove as much of the liquid phase from the cuttings as possible, thereby “drying” or “de-watering” the cuttings, which is the separation of liquids (namely, drilling fluids) from solids (namely, drill cuttings).

The present invention has particular, but not exclusive, application to land well drilling. Prior art methods have required that cuttings de-watering or “drying” equipment remain at the well site during the duration of the drilling operation, at considerable expense. The present invention provides a system of capturing drill cuttings in a first container, for later processing by the mobile drill cuttings drying system which is brought to the drilling location and used for relatively short time periods, after which the de-watered cuttings can be placed into transportable tanks and disposed of. As a result, the operator incurs only sporadic and relatively brief costs for operation of the mobile cuttings drying system, rather than having same on location throughout the duration of the drilling operation. It can be appreciated that significant cost savings results.

### BRIEF DESCRIPTION OF THE DRAWINGS

FIG. 1 is an overhead view of a first embodiment of the present invention.

FIG. 1A shows the discharge auger (70) rotated to a first position for roadway travel.

FIG. 2 is a side view of the first embodiment of the present invention.

FIG. 3 is another side view of certain components of the first embodiment of the present invention.

FIG. 4 is a side view of a second embodiment of the invention, comprising an integral inlet auger.

FIG. 5 is a top view of a second embodiment of the invention.

FIG. 5A shows the discharge auger (70) rotated to a first position for roadway travel.

FIG. 6 is a rear view of a second embodiment of the invention.

### DETAILED DESCRIPTION OF THE PREFERRED EMBODIMENTS OF THE INVENTION

An embodiment of the present invention will be described in sufficient detail to enable those having ordinary skill in the relevant art field to understand how same is manufactured and used. Broadly, the present invention comprises:
a cuttings drying unit;
a means for transporting the cuttings drying unit on a roadway, between drilling locations;
a means for conveying wet cuttings to an inlet of the cuttings drying unit; and
a means for conveying de-watered or dried cuttings from a discharge of the cuttings drying unit to a container.

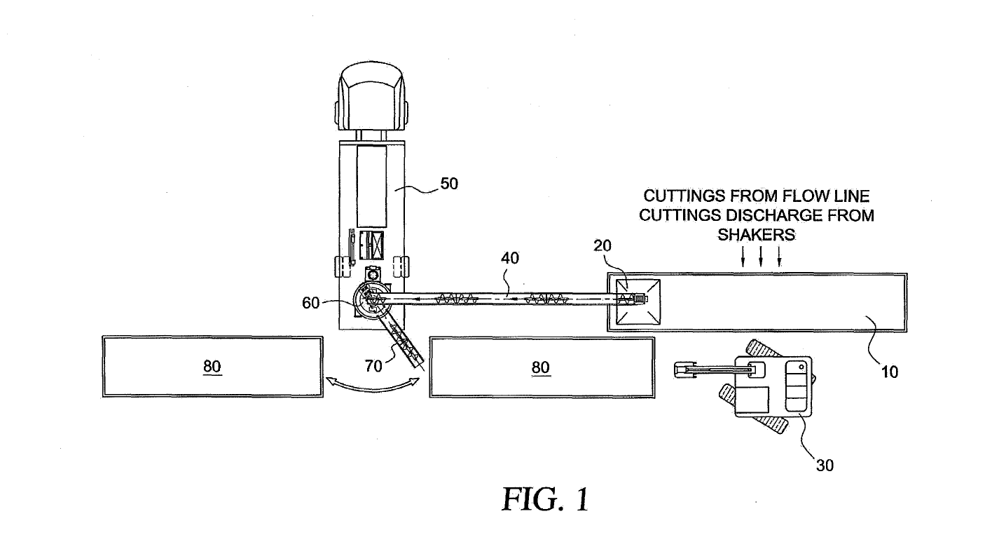

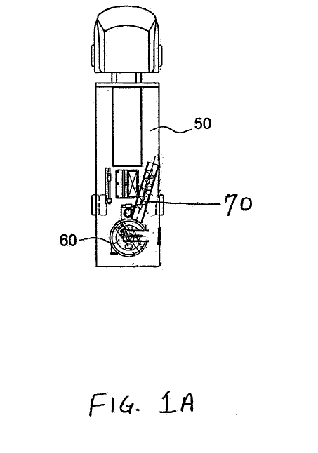

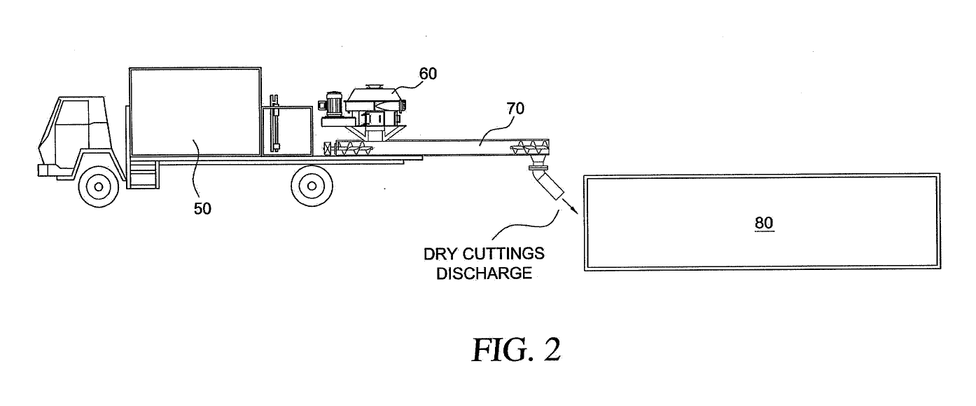

With reference to the drawings, a first embodiment of the invention is shown in FIGS. 1-3. Drill cuttings are received from the solids handling equipment on the drilling rig, for example the flowline or shaker discharge, as noted on the drawing, into a container, for example a cuttings tank 10. Typically, cuttings tank 10 is large enough to hold the cuttings generated in several days of drilling. A means for conveying the wet cuttings (which may be from cuttings tank 10) to an inlet of a cuttings drying unit is provided, which in one preferred embodiment comprises an auger hopper 20 and an inlet auger 40. When cuttings tank 10 is sufficiently loaded, the cuttings are moved into auger hopper 20, typically with a track hoe 30 or similar device with a bucket mounted thereon, from which inlet auger 40 then moves the cuttings from auger hopper 20 to the cuttings drying unit, as described below.

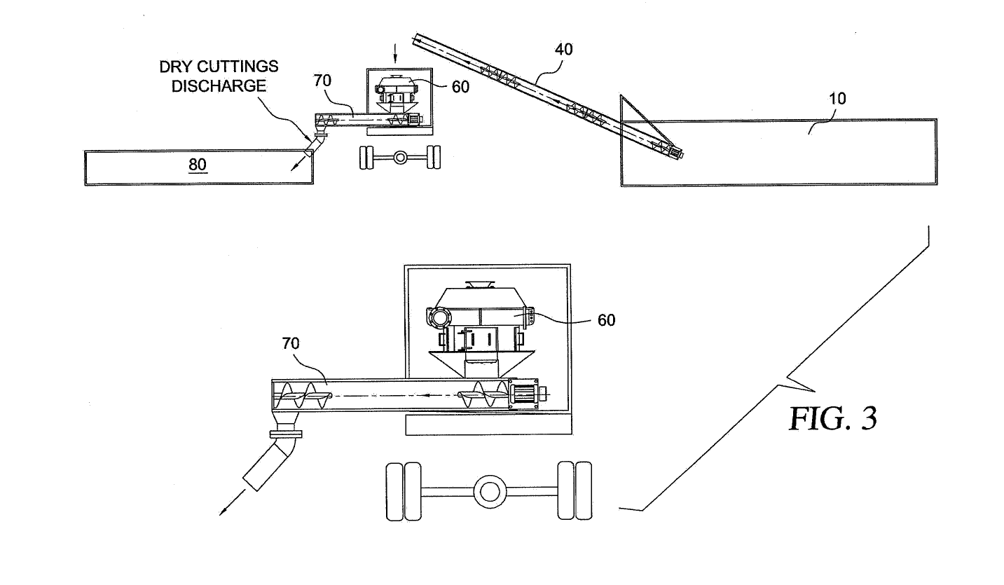

At suitable intervals, a cuttings drying unit is brought to the location to de-water the accumulated cuttings. Cuttings drying unit 60 is mounted on a means for transporting the cuttings drying unit on a roadway between drilling locations, which in one presently preferred embodiment comprises a truck 50 with an attached bed. It is to be understood that the term “truck” as used herein is used in its broadest manner, including but not limited to trucks with attached beds; truck/trailer combinations; or other similar means suitable for roadway travel and capable of carrying the drying unit. Truck 50, having cuttings drying unit 60 mounted thereon, comes to the drilling location and positions itself so as to receive cuttings from inlet auger 40, as best seen in FIGS. 1 and 3. It is understood that various forms of means for transporting the cuttings drying unit 60 on a roadway can be used, for example a truck with an attached bed; a trailer pulled by a truck or tractor, or any other similar arrangement known in the art. It is further understood that in the presently preferred embodiment cuttings drying unit 60 remains on the truck (or similar means for transporting, including remaining on a trailer) while the cuttings are being processed.

Cuttings drying unit 60 may take various forms, and is a commercially available component of the system of the present invention. A suitable cuttings drying unit is available from Centrifugal Services, Inc. of Raleigh, Ill., Model WSM-03. Generally, cuttings drying unit 60 uses centrifugal force to “spin dry” the cuttings, as is well known in the art, to generate one discharge stream of dry cuttings, and another discharge stream of liquid, which can be returned to the mud system. It is to be understood that the present invention encompasses cuttings drying units which may employ any form of drying process, not just via centrifugal force or similar means.

In the embodiment shown in FIGS. 1-3, inlet auger 40 is not connected to truck 50, but instead remains at the location; it is understood that each location therefore has an inlet auger 40.

As is known in the art, once the cuttings are received by cuttings drying unit 60, same are processed by centrifuge or similar means or processes, to remove the liquids therefrom. The dewatered cuttings are discharged from cuttings drying unit 60, are received by a means for conveying cuttings from a discharge of cuttings drying unit 60 to a container. In the illustrated embodiment, the means for conveying cuttings from a discharge of the cuttings drying unit comprises a discharge auger 70, which moves the dried cuttings to one or more dried cuttings containers 80.

Preferably, discharge auger 70 is mounted in a rotatable or swinging fashion, as shown in FIG. 1, and movable between a first position (shown in FIG. 1A) in which truck 50 can legally and safely travel a roadway while carrying discharge auger 70—preferably, discharge auger 70 being positioned so that it does not overhang the width of truck 50, and may be substantially aligned with the length of truck 50; and a second position (shown in FIG. 1) which permits the de-watered cuttings to be discharged into one of the cuttings boxes 80—typically, off to one side of truck 50. As can be seen in FIG. 1, this rotatable mounting of discharge auger 70 permits cuttings to be discharged into cuttings boxes 80 on either or both sides of truck 50. Cuttings box 80 can then be transported away for disposal, with empty cuttings boxes then brought to the location.

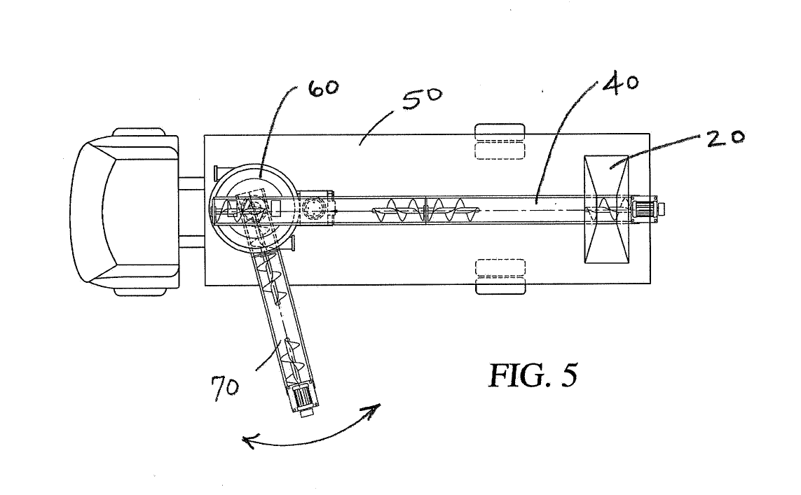

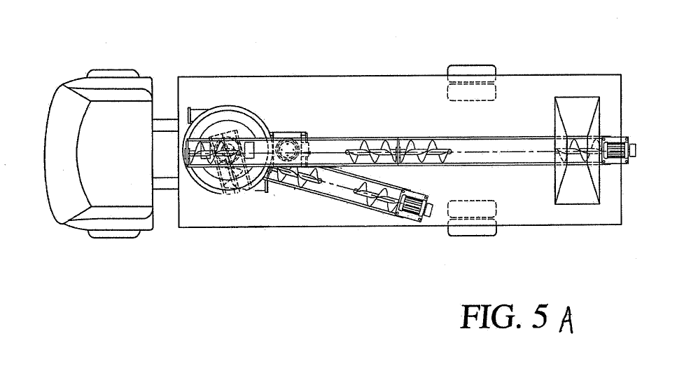

The rotatably-mounted discharge auger 70 is a key aspect of the present invention. As can be seen from the drawings, especially FIGS. 1 and 1A (and, for the second embodiment, FIGS. 5 and 5A), auger 70 can preferably be rotated to fit within the width of truck 50, for transport on a roadway, then rotated or swung into a position off to one side, as required, so that de-watered cuttings can be discharged into a container. If discharge auger 70 was not so rotatably mounted, then same would have to be mounted at the start of a cuttings drying job, then dismounted when the job was completed, so that the system could be transported on a roadway.

Once desired portion of the cuttings in cuttings tank 10 have been moved to the cuttings drying unit 60 and processed, truck 50 with cuttings drying unit 60 mounted thereon can leave the location and, if desired, move to another location for cuttings drying.

It can be readily understood from the preceding description that the present invention permits only periodic, short term use of the cuttings drying unit and associated equipment, in order to carry out the required cuttings drying. By way of example, cuttings tank 10 may be sized to hold approximately four days worth of drill cuttings. Truck 50 with cuttings drying unit 60 thereon would therefore come to the drilling location roughly every three to four days, and would process all of the cuttings in cuttings tank 10 in 3 to 4 hours. Truck 50 and cuttings drying unit 60 is then free to travel to other locations to process drill cuttings. It can be readily appreciated that significant cost savings result to the operator, by virtue of paying only a relatively few hours of rental/use fees for the truck and dryer, every 3 to 4 days. By contrast, prior art systems required full-time presence of the cuttings drying system on location.

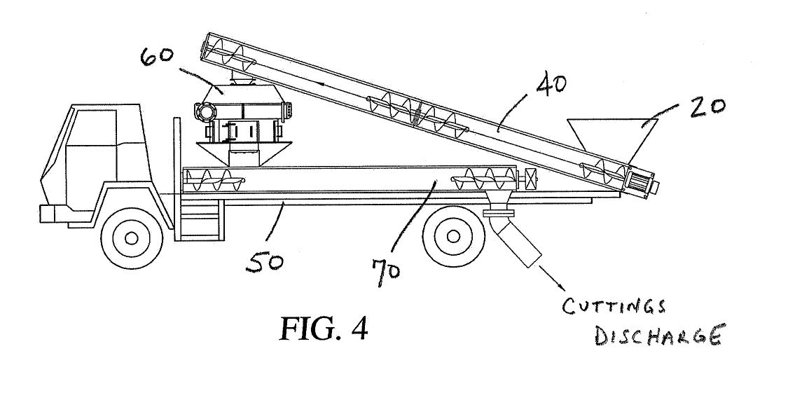

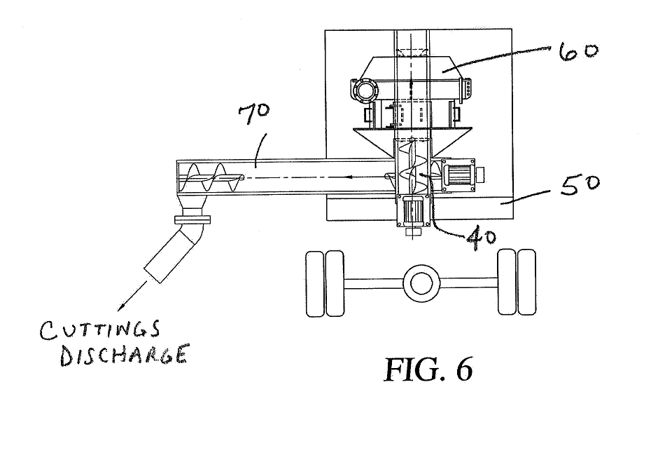

A second embodiment of the present invention is shown in FIGS. 4-6. In this embodiment, the means for conveying cuttings to an inlet of cuttings drying unit 60, which may comprise inlet auger 40 and hopper 20, are operatively connected to the means for transporting cuttings drying unit 60, namely truck 50, and positioned so as to move cuttings into the inlet of cuttings drying unit 60. This embodiment of the invention permits use of a single inlet auger 40, moved from location to location, along with the remaining components of the system, such as cuttings drying unit 60 and the means for conveying cuttings from the discharge of cuttings drying unit 60, namely discharge auger 70. This embodiment also preferably comprises a rotatable discharge auger 70 as was described in connect with the first embodiment. Discharge auger 70 can be rotated from the position seen in FIG. 5, where the discharge is positioned off to one side of truck 50, for discharging de-watered cuttings into a container, to the position shown in FIG. 5A. The position of discharge auger 70 shown in FIG. 5A permits legal and safe transport on a roadway. As can be readily appreciated, this embodiment eliminates the need to have an inlet auger 40 and hopper 20 installed at each location.

The method of the present invention comprises the steps of providing a cuttings drying unit mounted on a means for transporting said cuttings drying unit on a roadway; transporting the cuttings drying unit to a drilling location; conveying cuttings to an inlet of the drying unit, drying the cuttings, conveying cuttings from a discharge of the cuttings drying unit, then moving the drying unit away from the drilling location, in preparation for moving to another location. As described above, the periodic, relatively short term and temporary deployment of a road-transportable drying unit, which does not remain full time at a drilling location (that is, for the entirety of the drilling project), but is brought on location for only relatively brief, periodic intervals, is a key aspect of the invention.

It is to be understood that electric motors and other associated equipment are provided to power the various components of the present invention, with electrical power provided by electric generators or similar means (which may take the form of one or more “power packs” carried by the truck), or provided by rig power supply, all as is well known in the relevant art.

### Conclusion

While the preceding description contains many specificities, it is to be understood that same are presented only to describe some of the presently preferred embodiments of the invention, and not by way of limitation. Changes can be made to various aspects of the invention, without departing from the scope thereof. For example:
dimensions and capacities of the different elements of the system can be modified to suit particular applications;
different means can be used to move cuttings to and from the cuttings drying unit, namely the means for conveying cuttings to an inlet of the cuttings drying unit and the means for conveying cuttings from a discharge of the cuttings drying unit may comprise augers, belt conveyors, chutes, air-stream systems, vacuum systems, etc., all of which are within the scope of the present invention;
different manufacturers and models of cuttings drying unit may be used;
different mobile means can be used to move the various components of the system from location to location, such as mounting same on a trailer which is pulled by a truck; or by mounting same on the bed of a truck, with no trailer.

Therefore, the scope of the invention is to be determined not by the illustrative examples set forth above, but by the appended claims and their legal equivalents.

I claim:

1. A system for drying cuttings generated in the drilling of a well, comprising:
a) a cuttings drying unit;
b) a means for transporting said cuttings drying unit on a roadway, between drilling locations, wherein said cuttings drying unit remains on said means for transporting while cuttings are being dried;
c) a means for conveying cuttings to an inlet of said cuttings drying unit; and
d) a means for conveying cuttings from a discharge of said cuttings drying unit.

2. The system of claim 1, wherein said means for conveying cuttings to an inlet of said cuttings drying unit comprises an inlet auger and hopper, which receives cuttings discharged from a drilling rig.

3. The system of claim 2, wherein said means for conveying cuttings from a discharge of said cuttings drying unit comprises a discharge auger, positioned so as to receive cuttings discharged from said cuttings drying unit.

4. The system of claim 3, wherein said discharge auger is mounted on said means for transporting, and is rotatable between a first position wherein said discharge auger is positioned substantially within a width of said means for transporting, wherein roadway travel is legal, and a second position wherein said discharge auger is positioned to one side of said means for transporting, so that said cuttings can be discharged into a container.

5. The system of claim 4, wherein said inlet auger and hopper are connected to and remain on the means for transporting, thereby being transportable along with said cuttings drying unit.

6. The system of claim 1, wherein said means for conveying cuttings to an inlet of said cuttings drying unit remains at the drilling location for substantially the entirety of the duration of the drilling.

7. The system of claim 2, wherein said inlet auger and hopper remain at the drilling location for substantially the entirety of the duration of the drilling.

8. The system of claim 1, wherein said means for conveying cuttings from a discharge of said cuttings drying unit is connected to and remains on the means for transporting, thereby being transportable along with said cuttings drying unit.

9. The system of claim 8, wherein said means for conveying cuttings from a discharge of said cuttings drying unit is rotatable between a first position wherein said means for conveying cuttings is positioned substantially within a width of said means for transporting, wherein roadway travel is legal, and a second position wherein said means for conveying cuttings is positioned to one side of said means for transporting, so that said cuttings can be discharged into a container.

10. The system of claim 1, wherein said means for conveying cuttings to an inlet of said cuttings drying unit is connected to and remains on the means for transporting, thereby being transportable along with said cuttings drying unit.

11. A system for drying cuttings generated in the drilling of a well, comprising:
a) a cuttings drying unit mounted on a truck, whereby said cuttings drying unit can be transported on a roadway from drilling location to drilling location;
b) an inlet auger and hopper for conveying cuttings to an inlet of said cuttings drying unit; and
c) a discharge auger rotatably mounted on said truck and positioned to receive cuttings discharged from said cuttings drying unit, whereby said discharge auger is movable between a first position whereby said discharge auger is positioned within a width of said truck, thereby suitable for roadway movement; and a second position whereby said discharge auger can discharge cuttings into a container positioned away from said truck,
whereby said cuttings drying unit and said discharge auger are transported to a drilling location for temporary placement and processing of accumulated cuttings, for a period less than the duration of drilling on a well, then moved away from said drilling location.

12. The system of claim 11, wherein said inlet auger and hopper remain at a drilling location for substantially the entirety of the duration of drilling.

13. The system of claim 12, wherein said inlet auger and hopper are mounted on said truck, thereby being transportable along with said cuttings drying unit.

14. A method of on-location drying of cuttings generated at a drilling location, comprising the steps of:
a) providing a portable cuttings drying system, comprising:
a cuttings drying unit;
a means for transporting said cuttings drying unit on a roadway, between drilling locations, wherein said cuttings drying unit remains on said means for transporting while cuttings are being dried;
b) after a quantity of drill cuttings has accumulated at drilling location, moving said cuttings drying unit to said drilling location;
c) conveying drill cuttings to said cuttings drying unit, and drying said cuttings with said cuttings drying unit;
d) discharging said dried cuttings into a container;
e) continuing said drying of drill cuttings until a desired quantity of said cuttings have been processed;
f) moving said cuttings drying unit from said drilling location, after said desired quantity of cuttings have been processed, whereby said cuttings drying unit remains at said drilling location for a period of time substantially less than the entirety of the drilling project.

15. The system of claim 1, wherein said means for transporting comprises a truck and trailer.

16. The system of claim 1, wherein said means for conveying cuttings to an inlet of said cuttings drying unit comprises a vacuum system.
